(19) United States
(12) Patent Application Publication
(10) Pub. No.: US 2025/0045883 A1
(43) Pub. Date: Feb. 6, 2025

(54) IMAGE PROCESSING METHOD AND APPARATUS, DEVICE, AND MEDIUM

(71) Applicant: Beijing Zitiao Network Technology Co., Ltd., Haidian District, Beijing (CN)

(72) Inventor: Jiacheng LIU, Beijing (CN)

(21) Appl. No.: 18/718,146

(22) PCT Filed: Nov. 8, 2022
(86) PCT No.: PCT/CN2022/130595

§ 371 Date: Jun. 10, 2024

(30) Foreign Application Priority Data
Dec. 10, 2021 (CN) 202111509375.7

(51) Int. Cl. G06T 5/70; G06T 5/50; G06T 7/13; G06T 11/20

(52) U.S. Cl. CPC G06T 5/70; G06T 5/50; G06T 7/13; G06T 11/203; G06T 2207/10024; G06T 2207/20221; G06T 2210/56

(57) ABSTRACT

Embodiments of the present disclosure relate to an image processing method and apparatus, a device and a medium. The method comprises: obtaining a density image and a fluid shape image; blurring the density image on the basis of the fluid shape image to obtain a blurred image; determining a transition area, a fluid area and a normal area in the blurred image on the basis of a preset density threshold range; and rendering the transition area, the fluid area and the normal area to generate a target image.

### CROSS-REFERENCE TO RELATED APPLICATIONS

This application claims priority to and is based on a Chinese application with an application number 202111509375.7 and a filing date of Dec. 10, 2021, the aforementioned application is hereby incorporated by reference in its entirety.

### FIELD OF THE INVENTION

The invention relates to the technical field of image processing, in particular to image processing method, apparatus, device and medium.

### BACKGROUND

At present, there are more and more application scenarios of a two-dimensional fluid particle rendering fluid surface, usually, instead of the fluid density gradually and uniformly changing from the inside to the outside of the fluid, there exist a very small gradual change in the particle density inside the fluid, and there will occur a significant magnitude of jump when the edge of the fluid is reached.

In the related art, when the density of fluid particles is directly used to render a foam effect on the fluid surface, the transition between foams and ordinary fluids may be simply made hard, while because the particle density becomes sparse, a large area of foams appear in the center of spray at a big splash of spray, which does not meet expectations.

### DISCLOSURE OF THE INVENTION

In order to solve or at least partially solve the above technical problems, the present disclosure provides an image processing method, apparatus, device and medium.

An embodiment of the disclosure provides an image processing method, including the following steps:
acquiring a density image and a fluid shape image;
blurring the density image based on the fluid shape image to obtain a blurred image;
determining a transition region, a fluid region and an ordinary region in the blurred image based on a preset density threshold range;
rendering the transition region, the fluid region and the ordinary region to generate a target image.

An embodiment of the present disclosure also provides an image processing apparatus, including:
a drawing module configured to acquire a density image and a fluid shape image;
a blurring module configured to blur the density image based on the fluid shape image to obtain a blurred image;
a region determination module configured to determine a transition region, a fluid region and an ordinary region in the blurred image based on a preset density threshold range;
a rendering generation module configured to render the transition region, the fluid region and the ordinary region to generate a target image.

An embodiment of the disclosure also provides an electronic device, including a processor and a memory for storing instructions executable by the processor; the processor can be used for reading the executable instructions from the memory and executing the instructions to implement the image processing method provided by embodiments of the present disclosure.

An embodiment of the present disclosure also provides a computer-readable storage medium storing a computer program which, when executed by a computer, executes the image processing method provided by embodiments of the present disclosure.

An embodiment of the present disclosure also provides a computer program product including a computer program or instructions, which, when running on a computer, cause the computer to execute the image processing method provided by embodiments of the present disclosure.

An embodiment of the present disclosure also provides a computer program, which includes program codes that, when executed by a computer, cause the computer to execute the image processing method provided by embodiments of the present disclosure.

The image processing scheme provided by the embodiments of the present disclosure acquires a density image and a fluid shape image, blurs the density image based on the fluid shape image to obtain a blurred image, determines a transition region, a fluid region and an ordinary region in the blurred image based on a preset density threshold range, and finally renders the transition region, the fluid region and the ordinary region to generate a target image. Through the above technical scheme, by utilizing a fluid shape image to assist in blurring of the density image, the density transition in the blurred image becomes smoother and more natural, and the picture display effect can be improved.

### DESCRIPTION OF THE DRAWINGS

The above and other features, advantages and aspects of embodiments of the present disclosure will become more obvious in combination with accompanying drawings and with reference to embodiments of the present disclosure. Throughout the drawings, the same or similar reference numbers indicate the same or similar elements. It shall be understood that the drawings are illustrative, and the originals and elements are not drawn to scale.

FIG. 1a is an exemplary diagram of a two-dimensional fluid particle rendering fluid surface provided by an embodiment of the present disclosure;

FIG. 1b is an exemplary diagram of a foam effect on a rendering fluid surface provided by an embodiment of the present disclosure;

FIG. 2 is a schematic flowchart of an image processing method provided by an embodiment of the present disclosure;

FIG. 3 is a schematic flowchart of another image processing method provided by an embodiment of the present disclosure;

FIG. 4a is a schematic diagram of a kind of fluid particle provided by an embodiment of the present disclosure;

FIG. 4b is a schematic diagram of a density image provided by an embodiment of the present disclosure;

FIG. 4c is a schematic diagram of a fluid shape image provided by an embodiment of the present disclosure;

FIG. 5a is a schematic diagram of a blurred image provided by an embodiment of the present disclosure;

FIG. 5b is a schematic diagram of a transition region, a fluid region and an ordinary region provided by an embodiment of the present disclosure;

FIG. 6 is a schematic structural diagram of an image processing apparatus provided by an embodiment of the present disclosure;

FIG. 7 is a schematic structural diagram of an electronic device provided by an embodiment of the present disclosure.

### DETAILED DESCRIPTION OF PREFERRED EMBODIMENTS

Embodiments of the present disclosure will be described in more detail below with reference to the accompanying drawings. Although some embodiments of the present disclosure are shown in the drawings, it should be understood that the present disclosure can be embodied in various forms and should not be construed as limited to the embodiments set forth here, but rather, these embodiments are provided for a more thorough and complete understanding of the present disclosure. It should be understood that the drawings and embodiments of the present disclosure are only used for illustrative purposes, and are not used to limit the protection scope of the present disclosure.

It should be understood that the steps described in the method embodiments of the present disclosure may be performed in a different order and/or in parallel. Furthermore, method embodiments may include additional steps and/or omit performing the illustrated steps. The scope of the present disclosure is not limited in this respect.

As used herein, the term “including” and its variants are open-ended including, that is, “including but not limited to”. The term “based on” is “at least partially based on”. The term “one embodiment” means “at least one embodiment”; the term “another embodiment” means “at least one other embodiment”; the term “some embodiments” means “at least some embodiments”. Related definitions of other terms will be given in the following description.

It should be noted that the concepts of “first”, “second”, etc. mentioned in the present disclosure are only used to distinguish different apparatuses, modules or units, instead of limiting the order or interdependence of functionalities performed by these apparatuses, modules or units.

It should be noted that the modifications of “a” and “a plurality” mentioned in the present disclosure are schematic rather than limiting, and those skilled in the art should understand that unless otherwise clearly indicated in the context, they should be understood as “one or more”.

Names of messages or information exchanged among multiple apparatuses in embodiments of the present disclosure are only used for illustrative purposes, instead of limiting the scopes of these messages or information.

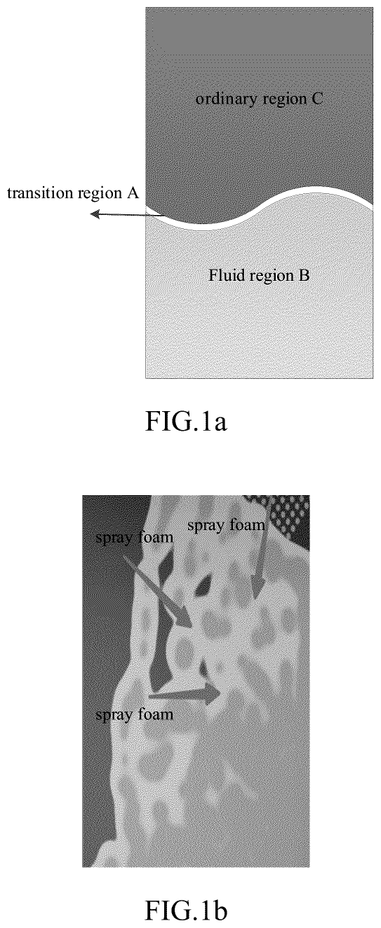

In a practical application, the density of fluid particles is directly used to render the foam effect on the fluid surface, so it is easy to make the transition between foams and ordinary fluids very hard, for example, the boundaries between transition region A, fluid region B and ordinary region C as shown in FIG. 1a are obvious, and the picture display effect is poor, meanwhile, because the particle density becomes sparse, a large area of foams appear in the center of spray at a big splash of spray, as shown in FIG. 1b, which does not meet expectations.

Aiming at the above problems, the present disclosure proposes an image processing method, which acquires a density image and a fluid shape image, blurs the density image based on the fluid shape image to obtain a blurred image, determines a transition region, a fluid region and an ordinary region in the blurred image based on a preset density threshold range, and finally renders the transition region, the fluid region and the ordinary region to generate a target image.

Therefore, by utilizing a fluid shape image to assist in blurring of the density image, the density transition in the blurred image becomes smoother and more natural, and the density of particles would not become spare even when the fluid splashes a large spray, which can avoid a large area of foams, meet the user's usage requirement, and improve the picture display effect.

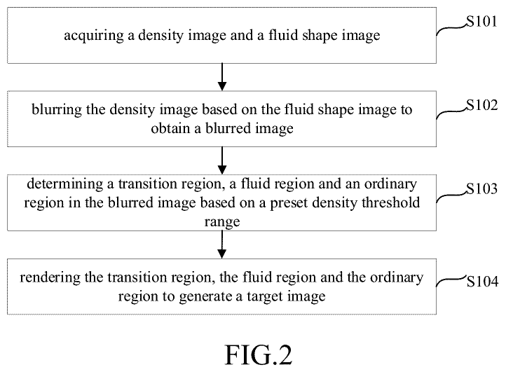

FIG. 2 is a flowchart of an image processing method provided by an embodiment of the present disclosure, which can be executed by an image processing apparatus, wherein the apparatus can be implemented by software and/or hardware, and generally can be integrated in an electronic device. As shown in FIG. 2, the method includes:

Step 101: acquiring a density image and a fluid shape image.

Among them, the density image refers to an image formed by superimposing a plurality of fluid particles with different sizes, and the fluid shape image refers to an image that can indicate which regions have fluids and which regions have no fluid in the image, that is, an image from which the fluid regions can be directly determined. Among them, the density image and the fluid shape image can be two separate images, or they can be in different channels of the same image, for example, the density image is in the R (Red) channel of image 1, and the flow shape image is in the G (Green) channel of image 1; where the density values of the same pixels in the density image and the fluid shape image are different.

In some embodiments, the acquiring the density image and the fluid shape image includes acquiring the density image and the fluid shape image based on a preset drawing algorithm and drawing data corresponding to the drawing algorithm.

In other embodiments, the acquiring the density image and the fluid shape image includes according to a preset image generation model, setting and inputting different image generation parameters into the image generation model respectively, to generate the density image and the fluid shape image.

The above two ways of acquiring the density image and the fluid shape image are only exemplary, and the present disclosure does not specifically limit the ways of acquiring the density image and the fluid shape image.

It should be noted that the sizes of the density image and the fluid shape image may not need to be completely consistent, the overall shape of fluid is determined by the fluid shape image, and the part of the density image that exceeds the fluid shape image may not need to be rendered.

Step 102: blurring the density image based on the fluid shape image to obtain a blurred image.

Among them, the blurring may refer to smoothing the density value of each pixel point in the density image, so that a blurring effect is produced on the density image and the middle points lose details, a blurred image can be obtained. In the embodiment of the present disclosure, the blurring may include one or more of mean blurring, Gaussian blurring, etc., which are specifically selected according to application requirements.

In some embodiments, the blurring the density image based on the fluid shape image to obtain a blurred image, includes: by taking a pixel in the fluid shape image as a central point, sampling pixel positions in the density image corresponding to the central point to obtain a plurality of pixels, performing calculation based on weight values and density values of the central point and the plurality of pixels to obtain a blurred value of the central point, and acquiring the blurred image based on the blurred value of each central point.

In another embodiment, the blurring the density image based on the fluid shape image to obtain a blurred image, includes: by taking a pixel in the fluid shape image as a central point, acquiring a plurality of pixels in the density image, performing average calculation based on the density values of the central point and the plurality of pixels to acquire a blurred value of the central point, and acquiring the blurred image based on the blurred value of each central point.

The above two ways of blurring the density image based on the fluid shape image to obtain a blurred image are only exemplary, and the present disclosure does not specifically limit the way of blurring the density image based on the fluid shape image to obtain a blurred image.

Step 103: determining a transition region, a fluid region and an ordinary region in the blurred image based on a preset density threshold range.

Step 104: rendering the transition region, the fluid region and the ordinary region to generate a target image.

Among them, the preset density threshold range can be set according to an application scenario, and the value of the preset density threshold range is not limited in embodiments of the present disclosure, and the preset density threshold range is usually selected between 0.4 and 0.9.

In an embodiment of the present disclosure, after acquiring the blurred image, the determining a transition region, a fluid region and an ordinary region in the blurred image based on a preset density threshold range, includes acquiring a maximum density value and a minimum density value in the preset density threshold range, comparing the density value of each pixel in the blurred image with the maximum density value and the minimum density value respectively, and acquiring pixels whose density values are smaller than the maximum density value and larger than the minimum density value as the transition region in the blurred image.

In an embodiment of the present disclosure, after the transition region, the fluid region and the normal region in the blurred image are determined, different color mixing are set according to data corresponding to respective regions so as to generate a target image for rendering. Therefore, in a part of the density image where the densities are sparse and uneven, after the density image is blurred based on the fluid shape image, the densities of pixels in the blurred image are smoother and more natural, so that the transition region determined based on the blurred image is more accurate, and the rendered target image better meets the user's usage requirement, and the image display effect can be improved.

The image processing scheme provided by embodiments of the disclosure acquires a density image and a fluid shape image, blurs the density image based on the fluid shape image to obtain a blurred image, determines a transition region, a fluid region and an ordinary region in the blurred image based on a preset density threshold range, and renders the transition region, the fluid region and the ordinary region to generate a target image. Through the above technical scheme, by drawing a fluid shape image to assist in blurring of the density image, the density transition in the blurred image becomes smoother and more natural, and the density of particles would not become spare even when the fluid splashes a large spray, which can avoid a large area of foams, meet the user's usage requirement, and improve the picture display effect.

In some embodiments, the acquiring the density image and the fluid shape image includes acquiring the density image and the fluid shape image based on a preset drawing algorithm and drawing data corresponding to the drawing algorithm.

Among them, different drawing algorithms can be selected for drawing according to the application scenarios and different drawings algorithms correspond to different drawing data, thus generating corresponding density images and fluid shape images.

In some embodiments, point drawing can be performed according to a preset first drawing algorithm and a preset first fluid particle density value to generate a plurality of first fluid particles, density values corresponding to the plurality of first fluid particles can be superimposed based on the position of each first fluid particle to obtain a density image, point drawing can be performed according to a preset second drawing algorithm and a preset constant value to generate a plurality of second fluid particles, and density values corresponding to the plurality of second fluid particles can be superimposed based on the position of each second fluid particle to obtain a fluid shape image.

Among them, the first drawing algorithm and the second drawing algorithm can be different drawing formulas, for example, the preset drawing formula may be R=a×r^{b}, where a and b are adjustable coefficients and r is a radius of fluid particle, and the values of a, b and r are not limited in embodiments of the present disclosure, and b is usually selected between 2 and 6.

Among them, a fluid particle may refer to the smallest material component in a flowable substance that can exist in a free state; the first fluid particle density value may refer to a density value of the first fluid particle which is used to represent the density of the fluid at the drawing position, and the superimposing may refer to that the density values of different fluid particles can be superimposed on each other when the particles coincide, i.e., at the same position. The more sense the fluid particles are, the more fluid particles coincide, and the greater the original density value of each pixel in the final density image is. Among them, the preset constant value can be set according to the application scenario, and the constant value is not limited in embodiments of the present disclosure.

Among them, the positions of the first fluid particles and the positions of the second fluid particles correspond to each other one by one, and the positions of the first fluid particles and the positions of the second fluid particles can be set in advance according to the requirement of the application scenario, so as to determine the fluid region in the target image.

It can be understood that first fluid particles with different density values can be generated by different first drawing algorithms and different first fluid particle density values.

In other embodiments, point drawing can be performed according to a preset third drawing algorithm and a preset second fluid particle density value to generate a plurality of third fluid particles, density values corresponding to the plurality of third fluid particles can be superimposed based on the position of each third fluid particle, to draw image data in a first designated channel of the target image as the density image, point drawing can be performed according to a preset third drawing algorithm and a preset constant value to generate a plurality of fourth fluid particles, and the plurality of fourth fluid particles can be superimposed based on the position of each fourth fluid particle, to draw image data in a second designated channel of the target image as the fluid shape image.

Among them, the designated channel may refer to RGBA (Red, Green, Blue and Alpha) four channels corresponding to the image format. Therefore, the image data corresponding to the density image and the fluid shape image are directly stored in different channels of an image, which further improves the processing efficiency, thereby improving the image display efficiency.

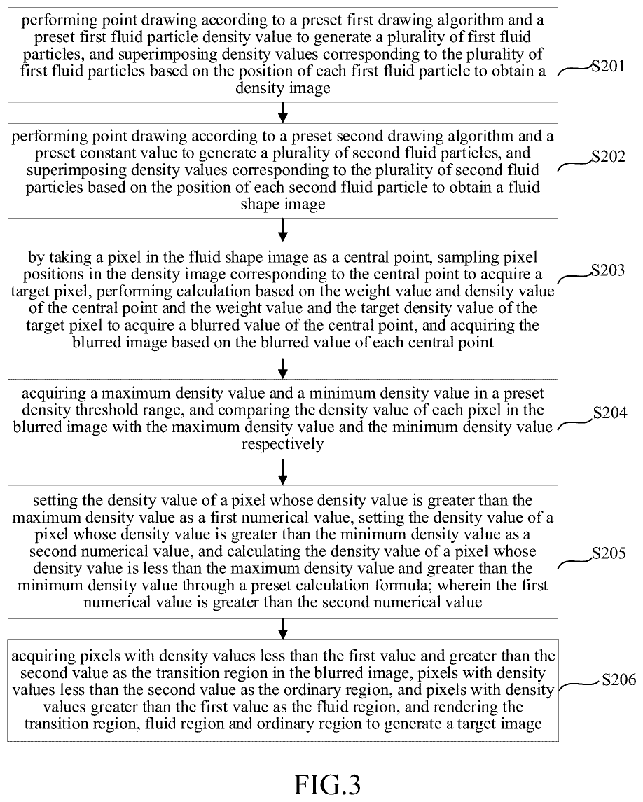

FIG. 3 is a flowchart of another image processing method provided by an embodiment of the present disclosure. This embodiment further optimizes the above image processing method on the basis of the above embodiment. As shown in FIG. 3, the method includes:

Step 201: performing point drawing according to a preset first drawing algorithm and a preset first fluid particle density value to generate a plurality of first fluid particles, and superimposing density values corresponding to the plurality of first fluid particles based on the position of each first fluid particle to obtain a density image.

Step 202: performing point drawing according to a preset second drawing algorithm and a preset constant value to generate a plurality of second fluid particles, and superimposing density values corresponding to the plurality of second fluid particles based on the position of each second fluid particle to obtain a fluid shape image.

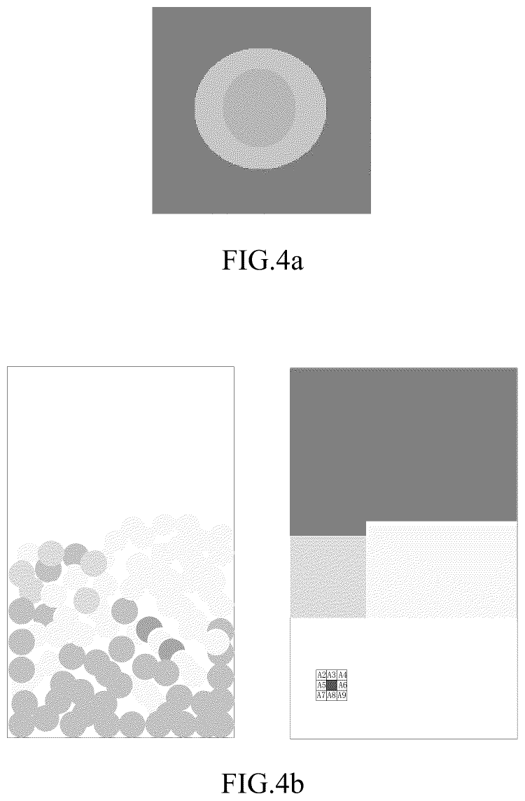

Among them, the preset first drawing algorithm and the preset second drawing algorithm can be the same or different, the first fluid particles are set according to the first drawing algorithm and corresponding drawing data, the position of each first fluid particle in the image to be drawn can be preset, so that at the set positions, corresponding first fluid particles can be generated, and each first fluid particle will spread out from the center of a circle with the density value gradually reducing, for example, the fluid particle schematic diagram as shown in FIG. 4a. Similarly, the radius of fluid particles can be selected and set according to the application scenario, which is not limited in the present disclosure herein.

Among them, under a condition that the preset first drawing algorithm is unchanged, the preset first fluid particle density values are different, and the drawn density values of the first fluid particles are different, so that when different first fluid particles coincide, the density values of the first fluid particles can be superimposed on each other to generate a density image, as shown in FIG. 4b.

Similarly, the second fluid particles are set according to the second drawing algorithm and the corresponding drawing data, the position of each second fluid particle in the image to be drawn can be set in advance, so that the corresponding second fluid particles can be generated at the set positions, and each second fluid particle will spread out from the center of a circle with the density value gradually reducing, and the preset constant value remains unchanged, therefore, under a condition that the preset second drawing algorithm is unchanged, the drawn second fluid particles have the same density values, so that when different second fluid particles coincide, the density values of the second fluid particles can be superimposed on each other to generate a flow shape image, as shown in FIG. 4c. That is to say, each fluid particle in the fluid shape image has the same density value, which only indicates whether there are fluid particles in this region, that is, indicating which regions in the image have fluid and which regions have no fluid, that is, the image of the fluid region can be directly determined, as shown in FIG. 4c, a region X is a fluid region, and the density value of each fluid particle in the fluid region is the same.

Therefore, the density image and the fluid shape image can be two separate images respectively, so that the fluid particles in the density image and the fluid shape image can be implemented by using optimal sizes, thereby improving the subsequent blurring effect and finally improving the picture display effect.

Step 203: by taking a pixel in the fluid shape image as a central point, sampling pixel positions in the density image corresponding to the central point to acquire a target pixel, performing calculation based on the weight value and density value of the central point and the weight value and the target density value of the target pixel to acquire a blurred value of the central point, and acquiring the blurred image based on the blurred value of each central point.

It can be understood that, the densities of some fluid particles in the density image are relatively low, and a large area of bubbles will appear if the rendering is performed directly, therefore, the density value of each fluid particle in the fluid region is the same, by taking a pixel in the fluid shape image as a central point, sampling pixel positions in the density image corresponding to the central point to acquire a target pixel, performing calculation based on the weight value and density value of the central point and the weight value and the target density value of the target pixel to acquire a blurred value of the central point, and acquiring the blurred image based on the blurred value of each central point.

For example, taking the density image of FIG. 4b and the fluid shape image of FIG. 4c as examples, each pixel in the fluid shape image of FIG. 4c is taken as a central point, and then the sampling is sequentially performed in the density image of FIG. 4b, for example, point A1 is a pixel in the fluid shape image as a central point, and the black pixels in FIG. 4b are pixels at a position corresponding to A1, and the black pixels are sequentially sampled, A2, A3, A4, A5, A6, A7, A8 and A9 can be acquired as target pixels, and weighted calculation is carried out according to the weight value and central density value of A1, as well as the weight values and target density values of A2, A3, A4, A5, A6, A7, A8 and A9, so as to obtain the blurred value of point A1.

Among them, the calculation formula can be set according to the application scenario, for example, the blurred value of point A1 is:

$${ω}_{1} \times A 1 + {ω}_{2} \times A 2 + {ω}_{3} \times A 3 + {ω}_{4} \times A 4 + {ω}_{5} \times A 5 + {ω}_{6} \times A 6 + {ω}_{7} \times A 7 + {ω}_{8} \times A 8 + {ω}_{9} \times A 9 ,$$

$$where {ω}_{1} + {ω}_{2} + {ω}_{3} + {ω}_{4} + {ω}_{5} + {ω}_{6} + {ω}_{7} + {ω}_{8} + {ω}_{9} = 1.$$

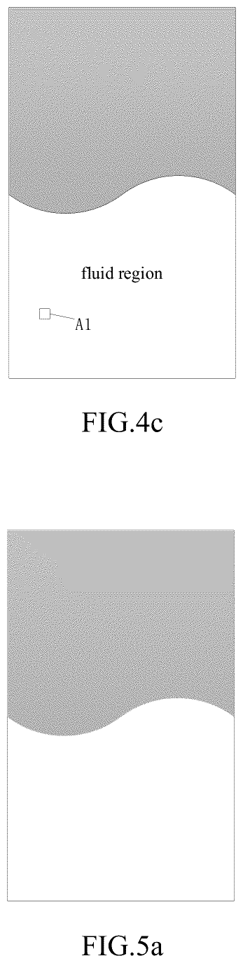

Therefore, after the blurring is performed by taking the density image shown in FIG. 4d and the fluid shape image shown in FIG. 4c as examples, a blurred image is acquired as shown in FIG. 5a.

It shall be understood that the larger the sampling range is, the better the blur processing effect is. In some embodiments, pixel positions in the density image corresponding to the central point can be acquired, a diagonal for the pixel positions can be obtained, the sampling can be performed on the diagonal to acquire the target pixels, and the sampling range can be expanded by sampling the target pixels on the diagonal, thus improving the blurring effect while saving performance.

In some embodiments, an original density value corresponding to each target pixel in the drawn density image may not be limited to the range of [0,1]. For example, when the density image is stored in any channel in RGB, the part greater than 1 and less than 0 will be lost. In order to further ensure the effect, the target density value corresponding to each target pixel can be obtained by performing calculation on the original density value corresponding to each target pixel with a preset coefficient, thus ensuring the blurring effect and improving the subsequent image display effect.

Step 204: acquiring a maximum density value and a minimum density value in a preset density threshold range, and comparing the density value of each pixel in the blurred image with the maximum density value and the minimum density value respectively.

In an embodiment of the present disclosure, the preset density threshold range can be selected and set according to application requirements, and the values of the preset density threshold range are not specifically limited in the present disclosure, and can usually be set between 0.5 and 0.9. Among them, if the preset density threshold range is relatively small, the transition region will be relatively narrow; if the preset density threshold range is relatively large, the transition region will be wide.

For example, the preset density threshold range is [0.5-0.8], the maximum density value is 0.8 and the minimum density value is 0.5, and the density value of each pixel in the blurred image can be compared with the maximum density value of 0.8 and the minimum density value of 0.5, respectively.

Step 205: setting the density value of a pixel whose density value is greater than the maximum density value as a first numerical value, setting the density value of a pixel whose density value is greater than the minimum density value as a second numerical value, and calculating the density value of a pixel whose density value is less than the maximum density value and greater than the minimum density value through a preset calculation formula; wherein the first numerical value is greater than the second numerical value.

In an embodiment of the present disclosure, the first numerical value and the second numerical value can be selected and set according to application requirements, and the first numerical value is greater than the second numerical value, the present disclosure does not specifically limit the value of the preset density threshold range, and generally the second numerical value is set to 0, and the first numerical value is set to be between 0.5 and 1.

Illustratively, the second numerical value is set to 0, the first numerical value is set to 1, the density value of each pixel in the blurred image is 0.9, the density value of the pixel can be set to the first numerical value of 1, the density value of each pixel in the blurred image is 0.2, and the density value of the pixel can be set to the first numerical value of 0, and the density value of each pixel in the blurred image is 0.6, the density value of the pixel can be determined by calculation according to the proportion of 0.6 between the first numerical value and the second numerical value.

In step 206, acquiring pixels with density values less than the first value and greater than the second value as the transition region in the blurred image, pixels with density values less than the second value as the ordinary region, and pixels with density values greater than the first value as the fluid region, and rendering the transition region, fluid region and ordinary region to generate a target image.

In an embodiment of the present disclosure, pixels with density values less than a first numerical value and greater than a second numerical value are used as the transition region in a blurred image, pixels with density values less than the second numerical value are used as the ordinary region, and pixels with density values greater than the first numerical value are used as the fluid region, and the transition region, fluid region and ordinary region are rendered to generate the target image. Taking FIG. 5a as an example, as shown in FIG. 5b, the transition region R, the fluid region S and the ordinary region T, it can be seen that the transition region in FIG. 5b is smoother and more natural, and the picture display effect is better.

Therefore, on the basis of the blurred image, the density values of the fluid particles in the preset density threshold range are mapped to the range between the first numerical value and the second numerical value, so that the accuracy of determining the transition region is further improved, and the picture display effect is improved.

According to the image processing scheme provided by the embodiments of the disclosure, performing point drawing according to a preset first drawing algorithm and a preset first fluid particle density value to generate a plurality of first fluid particles, and superimposing density values corresponding to the plurality of first fluid particles based on the position of each first fluid particle to obtain a density image; performing point drawing according to a preset second drawing algorithm and a preset constant value to generate a plurality of second fluid particles, and superimposing density values corresponding to the plurality of second fluid particles based on the position of each second fluid particle to obtain a fluid shape image, by taking a pixel in the fluid shape image as a central point, sampling pixel positions in the density image corresponding to the central point to acquire a target pixel, performing calculation based on the weight value and density value of the central point and the weight value and the target density value of the target pixel to acquire a blurred value of the central point, and acquiring the blurred image based on the blurred value of each central point, acquiring a maximum density value and a minimum density value in a preset density threshold range, and comparing the density value of each pixel in the blurred image with the maximum density value and the minimum density value respectively, setting the density value of a pixel whose density value is greater than the maximum density value as a first numerical value, setting the density value of a pixel whose density value is greater than the minimum density value as a second numerical value, and calculating the density value of a pixel whose density value is less than the maximum density value and greater than the minimum density value through a preset calculation formula; wherein the first numerical value is greater than the second numerical value, acquiring pixels with density values less than the first value and greater than the second value as the transition region in the blurred image, pixels with density values less than the second value as the ordinary region, and pixels with density values greater than the first value as the fluid region, and rendering the transition region, fluid region and ordinary region to generate a target image. Through the above technical scheme, by drawing a fluid shape image to assist in blurring of the density image, the density transition in the blurred image becomes smoother and more natural, and the density of particles would not become spare even when the fluid splashes a large spray, which can avoid a large area of foams, meet the user's usage requirement, and improve the picture display effect.

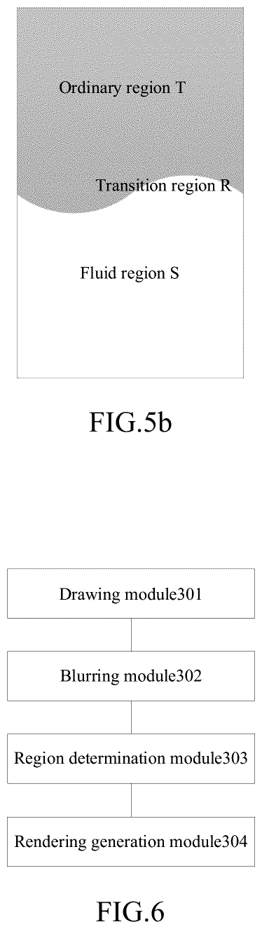

FIG. 6 is a schematic structural diagram of an image processing apparatus provided by an embodiment of the present disclosure, which can be realized by software and/or hardware and can be generally integrated in an electronic device. As shown in FIG. 6, the apparatus includes:
a drawing module 301 configured to acquire a density image and a fluid shape image;
a blurring module 302 configured to blur the density image based on the fluid shape image to obtain a blurred image;
a region determination module 303 configured to determine a transition region, a fluid region and an ordinary region in the blurred image based on a preset density threshold range;
a rendering generation module 304 configured to render the transition region, the fluid region and the ordinary region to generate a target image.

Optionally, the drawing module 301 is specifically configured to:
acquire the density image and the fluid shape image according to a preset drawing algorithm and drawing data corresponding to the drawing algorithm.

Optionally, the drawing module 301 is specifically configured to:
perform point drawing according to a preset first drawing algorithm and a preset first fluid particle density value to generate a plurality of first fluid particles,
superimpose density values corresponding to the plurality of first fluid particles based on the position of each first fluid particle to obtain a density image,
perform point drawing according to a preset second drawing algorithm and a preset constant value to generate a plurality of second fluid particles, and
superimpose density values corresponding to the plurality of second fluid particles based on the position of each second fluid particle to obtain a fluid shape image.

Optionally, the drawing module 301 is specifically configured to:
perform point drawing according to a preset third drawing algorithm and a preset second fluid particle density value to generate a plurality of third fluid particles,
superimpose density values corresponding to the plurality of third fluid particles based on the position of each third fluid particle, to draw image data in a first designated channel of the target image as the density image,
perform point drawing according to a preset third drawing algorithm and a preset constant value to generate a plurality of fourth fluid particles, and
superimpose the plurality of fourth fluid particles based on the position of each fourth fluid particle, to draw image data in a second designated channel of the target image as the fluid shape image.

Optionally, the blurring module 302 is specifically configured to:
by taking a pixel in the fluid shape image as a central point, sample pixel positions in the density image corresponding to the central point to acquire a target pixel,
perform calculation based on the weight value and density value of the central point and the weight value and the target density value of the target pixel to acquire a blurred value of the central point, and
acquire the blurred image based on the blurred value of each central point.

Optionally, the blurring module 302 is further specifically configured to:
acquire pixel positions in the density image corresponding to the central point,
acquire a diagonal for the pixel positions, wherein the sampling can be performed on the diagonal to acquire the target pixels.

Optionally, the apparatus may further include an acquisition calculation module, which is configured to:
acquire an original density value corresponding to each target pixel in the density image, perform calculation on the original density value corresponding to each target pixel with a preset coefficient to obtain a target density value corresponding to each target pixel.

Optionally, the region determination module 303 is specifically configured to:
acquire a maximum density value and a minimum density value in a preset density threshold range,
compare the density value of each pixel in the blurred image with the maximum density value and the minimum density value respectively,
set the density value of a pixel whose density value is greater than the maximum density value as a first numerical value, set the density value of a pixel whose density value is greater than the minimum density value as a second numerical value, and calculate the density value of a pixel whose density value is less than the maximum density value and greater than the minimum density value through a preset calculation formula; wherein the first numerical value is greater than the second numerical value,
acquire pixels with density values less than the first value and greater than the second value as the transition region in the blurred image, pixels with density values less than the second value as the ordinary region, and pixels with density values greater than the first value as the fluid region.

The image processing apparatus provided by the embodiments of the present disclosure can execute the image processing method provided by any embodiment of the present disclosure, and has corresponding functional modules and beneficial effects.

It should be noted that each of the above modules only belongs to a logical module classified according to the specific function it implements, instead of limiting its specific implementation manner, for example, it can be implemented in software, hardware, or a combination of software and hardware. In an actual implementation, each of the above modules may be implemented as separate physical entity, or may be implemented by a single entity (for example, a processor (CPU or DSP, etc.), an integrated circuit, etc.). In addition, the above-described modules are shown in the drawings in dash lines to indicate that such modules can actually not exist, the operations/functionalities that they implement can be implemented by the apparatus or a processing circuit itself.

In addition, although not shown, the apparatus may also include a memory that may store various information generated by the apparatus, various modules included in the apparatus during operation, programs and data for operations, data to be sent by the communication unit, etc. The memory may be a volatile memory and/or a non-volatile memory. For example, a memory may include, but is not limited to, random access memory (RAM), dynamic random-access memory (DRAM), static random-access memory (SRAM), read only memory (ROM), and flash memory. Of course, the memory may also be located external to the apparatus.

Embodiments of the present disclosure also provide a computer program product, including computer programs/instructions, which, when executed by a processor, realize the image processing method provided by any embodiment of the present disclosure.

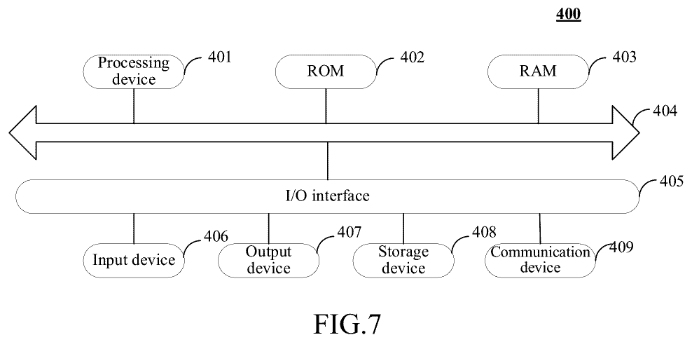

FIG. 7 is a schematic structural diagram of an electronic device provided by an embodiment of the present disclosure. Referring specifically to FIG. 7, there is shown a structural schematic diagram of an electronic device 400 suitable for implementing an embodiment of the present disclosure. The electronic device 400 in the embodiment of the present disclosure may include, but not limited to, a mobile terminal such as a mobile phone, a notebook computer, a digital broadcast receiver, a PDA (Personal Digital Assistant), a PAD (Tablet Computer), a PMP (Portable Multimedia Player), a vehicle-mounted terminal such as a vehicle navigation terminal, and a fixed terminal such as a digital TV and a desktop computer. The electronic device shown in FIG. 7 is only an example, and should not bring any limitation to functions and application scopes of the embodiments of the present disclosure.

As shown in FIG. 7, an electronic device 400 may include a processing device (such as a central processing unit, a graphics processor, etc.) 401, which may perform various appropriate actions and processes according to a program stored in a read-only memory (ROM) 402 or a program loaded from a storage device 408 into a random-access memory (RAM) 403. In the RAM 403, various programs and data required for the operation of the electronic device 400 are also stored. A processing device 401, a ROM 402 and a RAM 403 are connected to each other through a bus 404. An input/output (I/O) interface 405 is also connected to the bus 404.

Generally, the following devices can be connected to the I/O interface 405: an input device 406 including, for example, touch screen, touch pad, keyboard, mouse, camera, microphone, accelerometer, gyroscope, etc.; an output device 407 such as Liquid Crystal Display (LCD), speakers, vibrators, etc.; a storage device 408 including a magnetic tape, a hard disk, etc.; and a communication device 409. The communication device 409 may allow the electronic device 400 to communicate with other devices wirelessly or in wired so as to exchange data. Although FIG. 7 shows an electronic device 400 with various devices, it should be understood that it is not required to implement or have all the devices shown. More or fewer devices may alternatively be implemented or provided.

Particularly, according to embodiments of the present disclosure, the process described above with reference to the flowchart can be implemented as a computer software program. For example, an embodiment of the present disclosure includes a computer program product including a computer program carried on a non-transitory computer readable medium, the computer program containing program codes for executing the method shown in the flowchart. In such an embodiment, the computer program can be downloaded and installed from the network through the communication device 409, or installed from the storage device 408 or from the ROM 402. When executed by the processing device 401, the computer program carries out the above-mentioned functions defined in the image processing method of the embodiment of the present disclosure.

It should be noted that the above-mentioned computer-readable medium in this disclosure can be a computer-readable signal medium or a computer-readable storage medium or any combination of the two. The computer-readable storage medium can be, for example, but not limited to, an electrical, magnetic, optical, electromagnetic, infrared, or semiconductor system, apparatus or device, or any combination of the above. More specific examples of computer-readable storage media may include, but not limited to, an electrical connection with one or more wires, a portable computer diskette, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium can be any tangible medium that contains or stores a program that can be used by or in combination with an instruction execution system, apparatus, or device. In this disclosure, the computer-readable signal medium may include a data signal propagated in baseband or as a part of a carrier wave, in which computer-readable program codes are carried. This propagated data signals can take many forms, including, but not limited to, electromagnetic signals, optical signals, or any suitable combination of the above. The computer-readable signal medium can also be any computer-readable medium other than the computer-readable storage medium, which can send, propagate, or transmit the program for use by or in connection with the instruction execution system, apparatus, or device. The program code contained in the computer-readable medium can be transmitted by any suitable medium, including but not limited to electric wire, optical cable, RF (radio frequency), etc., or any suitable combination of the above.

In some embodiments, the client and the server can communicate by using any currently known or future developed network protocol such as HTTP (HyperText Transfer Protocol), and can be interconnected with any form or medium of digital data communication (e.g., communication network). Examples of communication networks include a local area network (“LAN”), a wide area network (“WAN”), an internet network (e.g., the Internet) and end-to-end network (e.g., ad hoc end-to-end network), as well as any currently known or future developed networks.

The above-mentioned computer-readable medium may be included in the electronic device; or it can exist alone without being loaded into the electronic device.

The above-mentioned computer-readable medium carries one or more programs, which, when executed by the electronic device, cause the electronic device to execute the following: receiving an information display trigger operation from a user during the play of video; acquiring at least two target information associated with the video; displaying a first target information in the at least two target information in an information display area in a playing page of the video, wherein the size of the information display area is smaller than that of the playing page; receiving a first switching trigger operation from a user, and switching the first target information displayed in the information display area to the second target information in the at least two target information.

Computer program codes for performing the operations of the present disclosure can be written in one or more programming languages or a combination thereof, including object-oriented programming languages such as Java, Smalltalk, and C++, as well as conventional procedural programming languages such as “C” language or similar programming languages. The program codes can be completely executed on the user's computer, partially executed on the user's computer, executed as an independent software package, partially executed on the user's computer, and partially executed on the remote computer, or completely executed on the remote computer or server. In a case related to remote computers, the remote computers can be connected to the user computers through any kind of networks, including Local Area Network (LAN) or Wide Area Network (WAN), or can be connected to external computers (for example, through the Internet with Internet service providers).

The flowcharts and block diagrams in the drawings illustrate the architecture, functions, and operations of possible embodiments of systems, methods, and computer program products according to various embodiments of the present disclosure. In this regard, each block in the flowchart or block diagram may represent a module, a program segment, or a part of the code, which contains one or more executable instructions for implementing specified logical functions. It should also be noted that in some alternative implementations, the functions labeled in the blocks may also occur in a different order than those labeled in the drawings. For example, two blocks shown in succession can actually be executed substantially in parallel, and sometimes they can be executed in the reverse order, depending on the functions involved. It should also be noted that each block in the block diagram and/or flowchart, and the combination of blocks in the block diagram and/or flowchart, can be realized by a dedicated hardware-based system that performs specified functions or operations, or can be realized by a combination of dedicated hardware and computer instructions.

The units involved in the embodiments according to the present disclosure can be realized by software or hardware. Among them, the name of a unit does not constitute the limitation for the unit itself in some cases.

The functions described above herein can be at least partially performed by one or more hardware logic components. For example, without limitation, exemplary types of hardware logic components that can be used may include field programmable gate array (FPGA), application specific integrated circuit (ASIC), application specific standard product (ASSP), system on chip (SOC), complex programmable logic device (CPLD) and so on.

In the context of the present disclosure, a machine-readable medium can be a tangible medium that can contain or store a program for use by or in connection with an instruction execution system, apparatus, or device. The machine-readable medium can be a machine-readable signal medium or a machine-readable storage medium. The machine-readable medium may include, but not limited to, electronic, magnetic, optical, electromagnetic, infrared, or semiconductor systems, devices or equipment, or any suitable combination of the foregoing. More specific examples of machine-readable storage medium may include electrical connections based on one or more wires, portable computer disks, hard disks, random access memories (RAM), read-only memories (ROM), erasable programmable read-only memories (EPROM or flash memories), optical fibers, compact disk read-only memories (CD-ROMs), optical storage devices, magnetic storage devices, or any suitable combination of the above.

According to one or more embodiments of the present disclosure, the present disclosure provides an image processing method, including:
acquiring a density image and a fluid shape image;
blurring the density image based on the fluid shape image to obtain a blurred image;
determining a transition region, a fluid region and an ordinary region in the blurred image based on a preset density threshold range;
rendering the transition region, the fluid region and the ordinary region to generate a target image.

According to one or more embodiments of the present disclosure, the acquiring a density image and a fluid shape image, may include:
acquiring the density image and the fluid shape image according to a preset drawing algorithm and drawing data corresponding to the drawing algorithm.

According to one or more embodiments of the present disclosure, in the image processing method provided by the present disclosure, the acquiring the density image and the fluid shape image according to a preset drawing algorithm and drawing data corresponding to the drawing algorithm, may include:
performing point drawing according to a preset first drawing algorithm and a preset first fluid particle density value to generate a plurality of first fluid particles,
superimposing density values corresponding to the plurality of first fluid particles based on the position of each first fluid particle to obtain a density image,
performing point drawing according to a preset second drawing algorithm and a preset constant value to generate a plurality of second fluid particles, and
superimposing density values corresponding to the plurality of second fluid particles based on the position of each second fluid particle to obtain a fluid shape image.

According to one or more embodiments of the present disclosure, in the image processing method provided by the present disclosure, the acquiring the density image and the fluid shape image according to a preset drawing algorithm and drawing data corresponding to the drawing algorithm, may include:
performing point drawing according to a preset third drawing algorithm and a preset second fluid particle density value to generate a plurality of third fluid particles,
superimposing density values corresponding to the plurality of third fluid particles based on the position of each third fluid particle, to draw image data in a first designated channel of the target image as the density image,
performing point drawing according to a preset third drawing algorithm and a preset constant value to generate a plurality of fourth fluid particles, and
superimposing the plurality of fourth fluid particles based on the position of each fourth fluid particle, to draw image data in a second designated channel of the target image as the fluid shape image.

According to one or more embodiments of the present disclosure, in the image processing method provided by the present disclosure, the blurring the density image based on the fluid shape image to obtain a blurred image, may include:
by taking a pixel in the fluid shape image as a central point, sampling pixel positions in the density image corresponding to the central point to acquire a target pixel,
performing calculation based on the weight value and density value of the central point and the weight value and the target density value of the target pixel to acquire a blurred value of the central point, and
acquiring the blurred image based on the blurred value of each central point.

According to one or more embodiments of the present disclosure, in the image processing method provided by the present disclosure, the sampling pixel positions in the density image corresponding to the central point to acquire a target pixel, may include:
acquiring pixel positions in the density image corresponding to the central point,
acquiring a diagonal for the pixel positions, wherein the sampling can be performed on the diagonal to acquire the target pixels.

According to one or more embodiments of the present disclosure, the image processing method provided by the present disclosure may further include:
acquiring an original density value corresponding to each target pixel in the density image,
performing calculation on the original density value corresponding to each target pixel with a preset coefficient to obtain a target density value corresponding to each target pixel.

According to one or more embodiments of the present disclosure, in the image processing method provided by the present disclosure, the determining a transition region, a fluid region and an ordinary region in the blurred image based on a preset density threshold range, may include:
acquiring a maximum density value and a minimum density value in a preset density threshold range,
comparing the density value of each pixel in the blurred image with the maximum density value and the minimum density value, respectively,
setting the density value of a pixel whose density value is greater than the maximum density value as a first numerical value, setting the density value of a pixel whose density value is greater than the minimum density value as a second numerical value, and calculating the density value of a pixel whose density value is less than the maximum density value and greater than the minimum density value through a preset calculation formula; wherein the first numerical value is greater than the second numerical value,
acquiring pixels with density values less than the first value and greater than the second value as the transition region in the blurred image, pixels with density values less than the second value as the ordinary region, and pixels with density values greater than the first value as the fluid region.

According to one or more embodiments of the present disclosure, the present disclosure provides an image processing apparatus including:
a drawing module configured to acquire a density image and a fluid shape image;
a blurring module configured to blur the density image based on the fluid shape image to obtain a blurred image;
a region determination module configured to determine a transition region, a fluid region and an ordinary region in the blurred image based on a preset density threshold range;
a rendering generation module configured to render the transition region, the fluid region and the ordinary region to generate a target image.

According to one or more embodiments of the present disclosure, in the image processing apparatus provided by the present disclosure, the drawing module is specifically configured to:
acquire the density image and the fluid shape image according to a preset drawing algorithm and drawing data corresponding to the drawing algorithm.

According to one or more embodiments of the present disclosure, in the image processing apparatus provided by the present disclosure, the drawing module is specifically configured to:
perform point drawing according to a preset first drawing algorithm and a preset first fluid particle density value to generate a plurality of first fluid particles,
superimpose density values corresponding to the plurality of first fluid particles based on the position of each first fluid particle to obtain a density image,
perform point drawing according to a preset second drawing algorithm and a preset constant value to generate a plurality of second fluid particles, and
superimpose density values corresponding to the plurality of second fluid particles based on the position of each second fluid particle to obtain a fluid shape image.

According to one or more embodiments of the present disclosure, in the image processing apparatus provided by the present disclosure, the drawing module is specifically configured to:
perform point drawing according to a preset third drawing algorithm and a preset second fluid particle density value to generate a plurality of third fluid particles,
superimpose density values corresponding to the plurality of third fluid particles based on the position of each third fluid particle, to draw image data in a first designated channel of the target image as the density image,
perform point drawing according to a preset third drawing algorithm and a preset constant value to generate a plurality of fourth fluid particles, and
superimpose the plurality of fourth fluid particles based on the position of each fourth fluid particle, to draw image data in a second designated channel of the target image as the fluid shape image.

According to one or more embodiments of the present disclosure, in the image processing apparatus provided by the present disclosure, the blurring module is specifically configured to:
by taking a pixel in the fluid shape image as a central point, sample pixel positions in the density image corresponding to the central point to acquire a target pixel,
perform calculation based on the weight value and density value of the central point and the weight value and the target density value of the target pixel to acquire a blurred value of the central point, and
acquire the blurred image based on the blurred value of each central point.

According to one or more embodiments of the present disclosure, in the image processing apparatus provided by the present disclosure, the blurring module is further specifically configured to:
acquire an original density value corresponding to each target pixel in the density image,
performing calculation on the original density value corresponding to each target pixel with a preset coefficient to obtain a target density value corresponding to each target pixel.

According to one or more embodiments of the present disclosure, in the image processing apparatus provided by the present disclosure, the region determination module is specifically configured to:
acquire a maximum density value and a minimum density value in a preset density threshold range,
compare the density value of each pixel in the blurred image with the maximum density value and the minimum density value respectively,
set the density value of a pixel whose density value is greater than the maximum density value as a first numerical value, set the density value of a pixel whose density value is greater than the minimum density value as a second numerical value, and calculate the density value of a pixel whose density value is less than the maximum density value and greater than the minimum density value through a preset calculation formula; wherein the first numerical value is greater than the second numerical value,
acquire pixels with density values less than the first value and greater than the second value as the transition region in the blurred image, pixels with density values less than the second value as the ordinary region, and pixels with density values greater than the first value as the fluid region.

According to one or more embodiments of the disclosure, the present disclosure provides an electronic device, including:
a processor; and
a memory for storing instructions executable by the processor;
the processor can be used for reading the executable instructions from the memory and executing the instructions to implement the image processing method provided by any embodiment of the present disclosure.

According to one or more embodiments of the disclosure, the present disclosure provides a computer-readable storage medium storing a computer program which, when executed by a computer, executes the image processing method provided by any embodiment of the present disclosure.

According to one or more embodiments of the disclosure, the present disclosure provides a computer program, which includes program codes that, when executed by a computer, cause the computer to execute the image processing method provided by any embodiment of the present disclosure.

The above description is only the preferred embodiment of the present disclosure and the explanation of the applied technical principles. Those skilled in the art should understand that the disclosure scope involved in this disclosure is not limited to the technical solution formed by the specific combination of the above technical features, but also covers other technical solutions formed by any combination of the above technical features or their equivalent features without departing from the above disclosed concept, for example, a technical solution formed by exchanging the above features with the technical features with similar functions disclosed in this disclosure, without limitation.

Furthermore, although the operations are depicted in a particular order, this should not be understood as requiring these operations to be performed in the particular order shown or in sequential order. Under certain circumstances, multitasking and parallel processing may be beneficial. Similarly, although the above discussion contains a number of specific implementation details, these should not be interpreted as limitations on the scope of the present disclosure. Some features described in the context of separate embodiments can also be implemented in a single embodiment in combination. On the contrary, various features described in the context of a single embodiment can also be implemented in multiple embodiments individually or in any suitable sub-combination.

Although the subject matter has been described in language specific to structural features and/or logical acts of methods, it should be understood that the subject matter defined in the appended claims is not necessarily limited to the specific features or acts described above. On the contrary, the specific features and actions described above are only exemplary forms of implementing the claims.

1. An image processing method, comprising:
acquiring a density image and a fluid shape image;
blurring the density image based on the fluid shape image to obtain a blurred image;
determining a transition region, a fluid region and an ordinary region in the blurred image based on a preset density threshold range;
rendering the transition region, the fluid region and the ordinary region to generate a target image.

2. The image processing method of claim 1, wherein, the acquiring a density image and a fluid shape image, comprises:
acquiring the density image and the fluid shape image according to a preset drawing algorithm and drawing data corresponding to the drawing algorithm.

3. The image processing method of claim 2, wherein, the acquiring the density image and the fluid shape image according to a preset drawing algorithm and drawing data corresponding to the drawing algorithm, comprises:
performing point drawing according to a preset first drawing algorithm and a preset first fluid particle density value to generate a plurality of first fluid particles,
superimposing density values corresponding to the plurality of first fluid particles based on the position of each first fluid particle to obtain a density image,
performing point drawing according to a preset second drawing algorithm and a preset constant value to generate a plurality of second fluid particles, and
superimposing density values corresponding to the plurality of second fluid particles based on the position of each second fluid particle to obtain a fluid shape image.

4. The image processing method of claim 2, wherein, the acquiring the density image and the fluid shape image according to a preset drawing algorithm and drawing data corresponding to the drawing algorithm, comprises:
performing point drawing according to a preset third drawing algorithm and a preset second fluid particle density value to generate a plurality of third fluid particles,
superimposing density values corresponding to the plurality of third fluid particles based on the position of each third fluid particle, to draw image data in a first designated channel of the target image as the density image,
performing point drawing according to a preset third drawing algorithm and a preset constant value to generate a plurality of fourth fluid particles, and
superimposing the plurality of fourth fluid particles based on the position of each fourth fluid particle, to draw image data in a second designated channel of the target image as the fluid shape image.

5. The image processing method of claim 1, wherein, the acquiring a density image and a fluid shape image, comprises:
based on a preset image generation model, setting and inputting different image generation parameters into the image generation model to generate the density image and the fluid shape image.

6. The image processing method of claim 1, wherein, the blurring the density image based on the fluid shape image to obtain a blurred image, comprises:
by taking a pixel in the fluid shape image as a central point, sampling pixel positions in the density image corresponding to the central point to acquire a target pixel,
performing calculation based on the weight value and density value of the central point and the weight value and the target density value of the target pixel to acquire a blurred value of the central point, and
acquiring the blurred image based on the blurred value of each central point.

7. The image processing method of claim 1, wherein, the sampling pixel positions in the density image corresponding to the central point to acquire a target pixel, comprises:
acquiring pixel positions in the density image corresponding to the central point,
acquiring a diagonal for the pixel positions, wherein the sampling is performed on the diagonal to acquire the target pixels.

8. The image processing method of claim 6, further comprising:
acquiring an original density value corresponding to each target pixel in the density image,
performing calculation on the original density value corresponding to each target pixel with a preset coefficient to obtain a target density value corresponding to each target pixel.

9. The image processing method of claim 6, wherein, the blurring the density image based on the fluid shape image to obtain a blurred image comprises: by taking a pixel in the fluid shape image as a central point, acquiring a plurality of pixels in the density image, averaging the density values of the central point and the plurality of pixels to obtain a blurred value of the central point, and acquiring a blurred image based on the blurred value of each central point.

10. The image processing method of claim 6, wherein, the determining a transition region, a fluid region and an ordinary region in the blurred image based on a preset density threshold range, comprises:
acquiring a maximum density value and a minimum density value in a preset density threshold range,
comparing the density value of each pixel in the blurred image with the maximum density value and the minimum density value, respectively,
setting the density value of a pixel whose density value is greater than the maximum density value as a first numerical value, setting the density value of a pixel whose density value is greater than the minimum density value as a second numerical value, and calculating the density value of a pixel whose density value is less than the maximum density value and greater than the minimum density value through a preset calculation formula; wherein the first numerical value is greater than the second numerical value,
acquiring pixels with density values less than the first value and greater than the second value as the transition region in the blurred image, pixels with density values less than the second value as the ordinary region, and pixels with density values greater than the first value as the fluid region.

11. The image processing method of claim 1, wherein the rendering the transition region, the fluid region and the ordinary region to generate a target image, comprises:
performing rendering by setting different color mixing according to data corresponding to the transition region, the fluid region and the common region, to generate the target image.

12. (canceled)

13. An electronic device, comprising:
a processor; and
a memory for storing instructions executable by the processor;
wherein the processor is used for reading the executable instructions from the memory and executing the instructions to implement:
acquiring a density image and a fluid shape image;
blurring the density image based on the fluid shape image to obtain a blurred image;
determining a transition region, a fluid region and an ordinary region in the blurred image based on a preset density threshold range;
rendering the transition region, the fluid region and the ordinary region to generate a target image.

14. A non-transitory computer-readable storage medium storing a computer program which, when executed by a computer, causes the computer to implement:
acquiring a density image and a fluid shape image;
blurring the density image based on the fluid shape image to obtain a blurred image;
determining a transition region, a fluid region and an ordinary region in the blurred image based on a preset density threshold range;
rendering the transition region, the fluid region and the ordinary region to generate a target image.

15-16. (canceled)

17. The electronic device of claim 13, wherein, the acquiring a density image and a fluid shape image, comprises:
acquiring the density image and the fluid shape image according to a preset drawing algorithm and drawing data corresponding to the drawing algorithm
wherein the acquiring the density image and the fluid shape image according to a preset drawing algorithm and drawing data corresponding to the drawing algorithm, comprises:
performing point drawing according to a preset first drawing algorithm and a preset first fluid particle density value to generate a plurality of first fluid particles,
superimposing density values corresponding to the plurality of first fluid particles based on the position of each first fluid particle to obtain a density image,
performing point drawing according to a preset second drawing algorithm and a preset constant value to generate a plurality of second fluid particles, and
superimposing density values corresponding to the plurality of second fluid particles based on the position of each second fluid particle to obtain a fluid shape image, and/or
wherein, the acquiring the density image and the fluid shape image according to a preset drawing algorithm and drawing data corresponding to the drawing algorithm, comprises:
performing point drawing according to a preset third drawing algorithm and a preset second fluid particle density value to generate a plurality of third fluid particles,
superimposing density values corresponding to the plurality of third fluid particles based on the position of each third fluid particle, to draw image data in a first designated channel of the target image as the density image,
performing point drawing according to a preset third drawing algorithm and a preset constant value to generate a plurality of fourth fluid particles, and
superimposing the plurality of fourth fluid particles based on the position of each fourth fluid particle, to draw image data in a second designated channel of the target image as the fluid shape image.

18. The electronic device of claim 13, wherein, the blurring the density image based on the fluid shape image to obtain a blurred image, comprises:
by taking a pixel in the fluid shape image as a central point, sampling pixel positions in the density image corresponding to the central point to acquire a target pixel,
performing calculation based on the weight value and density value of the central point and the weight value and the target density value of the target pixel to acquire a blurred value of the central point, and
acquiring the blurred image based on the blurred value of each central point.

19. The electronic device of claim 13, wherein, the determining a transition region, a fluid region and an ordinary region in the blurred image based on a preset density threshold range, comprises:
acquiring a maximum density value and a minimum density value in a preset density threshold range,
comparing the density value of each pixel in the blurred image with the maximum density value and the minimum density value, respectively,
setting the density value of a pixel whose density value is greater than the maximum density value as a first numerical value, setting the density value of a pixel whose density value is greater than the minimum density value as a second numerical value, and calculating the density value of a pixel whose density value is less than the maximum density value and greater than the minimum density value through a preset calculation formula; wherein the first numerical value is greater than the second numerical value,
acquiring pixels with density values less than the first value and greater than the second value as the transition region in the blurred image, pixels with density values less than the second value as the ordinary region, and pixels with density values greater than the first value as the fluid region.

20. The electronic device of claim 13, wherein the rendering the transition region, the fluid region and the ordinary region to generate a target image, comprises:
performing rendering by setting different color mixing according to data corresponding to the transition region, the fluid region and the common region, to generate the target image.

21. The non-transitory computer-readable storage medium of claim 14, wherein, the acquiring a density image and a fluid shape image, comprises:
acquiring the density image and the fluid shape image according to a preset drawing algorithm and drawing data corresponding to the drawing algorithm
wherein the acquiring the density image and the fluid shape image according to a preset drawing algorithm and drawing data corresponding to the drawing algorithm, comprises:
performing point drawing according to a preset first drawing algorithm and a preset first fluid particle density value to generate a plurality of first fluid particles,
superimposing density values corresponding to the plurality of first fluid particles based on the position of each first fluid particle to obtain a density image,
performing point drawing according to a preset second drawing algorithm and a preset constant value to generate a plurality of second fluid particles, and
superimposing density values corresponding to the plurality of second fluid particles based on the position of each second fluid particle to obtain a fluid shape image, and/or
wherein, the acquiring the density image and the fluid shape image according to a preset drawing algorithm and drawing data corresponding to the drawing algorithm, comprises:
performing point drawing according to a preset third drawing algorithm and a preset second fluid particle density value to generate a plurality of third fluid particles,
superimposing density values corresponding to the plurality of third fluid particles based on the position of each third fluid particle, to draw image data in a first designated channel of the target image as the density image,
performing point drawing according to a preset third drawing algorithm and a preset constant value to generate a plurality of fourth fluid particles, and
superimposing the plurality of fourth fluid particles based on the position of each fourth fluid particle, to draw image data in a second designated channel of the target image as the fluid shape image.

22. The non-transitory computer-readable storage medium of claim 14, wherein, the blurring the density image based on the fluid shape image to obtain a blurred image, comprises:
by taking a pixel in the fluid shape image as a central point, sampling pixel positions in the density image corresponding to the central point to acquire a target pixel,
performing calculation based on the weight value and density value of the central point and the weight value and the target density value of the target pixel to acquire a blurred value of the central point, and
acquiring the blurred image based on the blurred value of each central point.

23. The non-transitory computer-readable storage medium of claim 14, wherein, the determining a transition region, a fluid region and an ordinary region in the blurred image based on a preset density threshold range, comprises:
acquiring a maximum density value and a minimum density value in a preset density threshold range,
comparing the density value of each pixel in the blurred image with the maximum density value and the minimum density value, respectively,
setting the density value of a pixel whose density value is greater than the maximum density value as a first numerical value, setting the density value of a pixel whose density value is greater than the minimum density value as a second numerical value, and calculating the density value of a pixel whose density value is less than the maximum density value and greater than the minimum density value through a preset calculation formula; wherein the first numerical value is greater than the second numerical value,
acquiring pixels with density values less than the first value and greater than the second value as the transition region in the blurred image, pixels with density values less than the second value as the ordinary region, and pixels with density values greater than the first value as the fluid region.
